(19) United States
(12) Patent Application Publication
(10) Pub. No.: US 2015/0235785 A1
(43) Pub. Date: Aug. 20, 2015

(54) WATER-TIGHT MICRO-SWITCH

(71) Applicant: Johnson Electric S.A., Murten (CH)

(72) Inventor: Martin Koepsell, Ennepetal (DE)

(21) Appl. No.: 14/622,229

(22) Filed: Feb. 13, 2015

(30) Foreign Application Priority Data
Feb. 15, 2014 (DE) 102014002104.1
Apr. 10, 2014 (DE) 102014005433.0

(51) Int. Cl. H01H 9/04

(52) U.S. Cl. CPC H01H 9/04; H01H 2229/044

(57) ABSTRACT

A micro-switch has a housing formed by a switch base and a switch cover. The switch has an actuating element for operating a switching mechanism disposed within the housing. The switch cover and the actuating element are formed as a one-piece component, preferably by molding. The switch cover is bonded to the switch base. Thus a seal between the housing and the actuating element is eliminated.

### CROSS REFERENCE TO RELATED APPLICATIONS

This non-provisional patent application claims priority under 35 U.S.C. §119(a) from Patent Application No. DE102014002104.1 filed in Germany on Feb. 15, 2014, and from Patent Application No. DE102014005433.0 filed in Germany on Apr. 10, 2014, the entire contents of which are hereby incorporated by reference.

### FIELD OF THE INVENTION

This invention relates to an electrical switch and in particular, to a water-tight micro-switch.

### BACKGROUND OF THE INVENTION

In many applications switches are required to reliably function under difficult environmental conditions. Such applications are typical for automotive, nautical, medical, and industrial environments. Stresses caused by climate, media, pressurized water or switching under water or covered by fluids constitute stresses, which switches as unprotected components, frequently cannot withstand.

The switch base and the switch cover form the housing of the micro-switch accommodating a switching mechanism. Contacts are received inside the housing and are run through the switch base into the exterior of the micro-switch to form terminals of the switch. An actuating element runs through the switch cover to operate the switching mechanism.

In principle the interior of the switch must be protected against external media, and that is what the switch cover is meant to do. Problems arise, however, when an actuating element is run through the switch cover, because a weak point is created in this spot. Admittedly sealing elements, such as bellows, are provided to seal the joint between the cover and the actuating element but sealing elements of this kind tend to start leaking, in particular with longer-term use. Actuating element, sealing element (bellows) and cover are different parts or made of different materials.

The EP0600634 describes a micro-switch in which the bellows and the cover are manufactured by way of a 2-component injection molding process.

The DE202006018987(U1) describes an embossing process for sealingly connecting the bellows (elastomer) and cover (hard plastic).

The EP1585155 describes a form-locking connection between bellows (elastomer) and plunger (hard plastic).

Micro-switches of the prior art are not permanently sealed when subjected to pressurized water (high-pressure cleaners, possibly for a given small nozzle distance) or when being switched under a water column.

### SUMMARY OF THE INVENTION

Hence there is a desire for a micro-switch, the inside of which is sealed against the intrusion of media.

This is achieved in the present invention by combining the actuating element, the bellows and the cover to form a single component multi-functional cover. This cover is materially bonded to the base and thereby sealed. The pass-through points for the electric connections (terminals) are sealed to the base.

The ingress of media is prevented through elimination of the typical pass-through points between plunger and bellows, bellows and cover. The cover together with the integrated actuating element is, due to its shape, flexibly constructed, and thus able to cope with the necessary actuating travel over the long term.

As a result correspondingly adapted shapes can be realized for hard or soft cover materials. A hard cover material is suited substantially better for further processing steps, in particular for manufacturing sealed electrical connections by employing casting with plastic at the product design stage.

A specially designed jump switching system permits short actuating travel for switching and a one-piece design for the cover, even when using a hard material.

With the micro-switch according to the invention the switch cover and the actuating element form one component which means that advantageously there is no possibility of a leak being created between these parts. Therefore a seal such as a bellows is eliminated, without a leak occurring between the switch cover and the actuating element. As the actuating element is integrated with the switch cover thereby forming a one-piece component, the switch cover participates in the actuation of contacts inside the micro-switch. This may for example be effected by indenting portions of the switch cover.

Preferably, the actuating element is a plunger molded into the switch cover. According to this further development the actuating element still exists, although it is implemented as a plunger formed with the cover as a single piece. A plunger is a means for transferring a force in particular along the longitudinal center axis of the plunger, in order, for example, to operate a switching mechanism. Since with this movement of the plunger arranged in the switch cover, the switch cover is also moved, the switch cover is preferably made from a flexible material. In addition provision may be made for a relatively small movement of the plunger to be translated into a switching operation of the switching mechanism involved, for example through the use of a jump switch.

A further development of the invention provides for the switch cover to comprise wall sections with the plunger being molded into a wall section. In this way a special design can be achieved for the wall section together with the plunger. This wall section may be made thinner than other wall sections, in order to make it more flexible. At least one thicker area may be provided about the plunger as reinforcement. Generally, a switch cover would comprise a rectangular shape, so that the wall section with the molded-in plunger can be the wall section of the switch cover that lies on top. The plunger would then extend roughly vertical, and it could comprise sections formed outside and inside the switch cover.

Preferably, the switch cover to be manufactured from a soft material, e.g. an elastomer such as such as PE-HD or ethylene-propylene-diene rubber (EPDM). In this case the switch cover as a whole can yield when the switch is actuated. Alternatively it is possible to manufacture the switch cover from a hard material, e.g. polyamide with glass fiber (PA GF30, such as PA66GF30). In this case a smaller travel for the actuating element is provided, and for an appropriate contact configuration this may be translated into a switching contact jump.

According to a still further development of the invention provision is made for the switch cover to be manufactured from the same or similar material as the switch base. In this case the material properties of the switch cover and the switch base are identical or similar, and with this configuration in particular it is possible, according to a next further development of the invention, for the switch base and the switch cover to form a material bond. This further development has the effect of eliminating two weak points, i.e. the point at which the actuating element is run through into the interior of the micro-switch, and a further weak point at the interface between switch cover and switch base. A materially bonded connection seals this interface against leaking of liquids and moisture, the switch is completely sealed as a result of the material bonding. Pass-through points for movable parts are eliminated.

The bonded connection between switch base and switch cover is preferably achieved by gluing. To this effect the opposing, respectively uninterrupted surfaces of switch base and switch cover are pressed together. Penetration of the liquid adhesive into the micro-switch during the gluing process is thereby prevented. Preferably, the contacts protruding from the switch base are glued to the switch base. This is ideally done at the same time as the switch cover is glued to the switch base. Their pass-through points are thus sealed against the switch base. All possible paths through which media could penetrate into the micro-switch are thus eliminated due to the material bond.

As an alternative to gluing a material bond between the switch base and switch cover may be achieved by welding.

Inside the micro-switch a stop for the plunger may be additionally arranged. During a switching operation the plunger is thus allowed to move, at most, up to this stop, even if forces of misuse occur, and it then contacts the stop. Damage to the micro-switch is thus avoided.

With regard to the switch cover, provision may be additionally made for it to be configured as an injection-molding product, the injection point of which during its manufacture lies in the area of the plunger. Loadable molecule chains would then spread out star-like away from the plunger because these molecule chains will arrange themselves in a star-shape from the injection point. Later the plunger forms the force-introduction point for a switch actuation, and due to this injection-molding configuration the switch cover can withstand the occurring forces.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIGS. 1, 1a, 2, 2a, 3, and 3a respectively show perspective views and side views of a micro-switch with a partially opened switch cover in different switching states;

FIGS. 4 and 4a show side views of an alternative embodiment of the switch of FIG. 1; and

FIGS. 5, 5a, and 5b show perspective views of the switch of FIG. 1 with the switch cover shown closed in the different switching states.

### DETAILED DESCRIPTION OF THE PREFERRED EMBODIMENTS

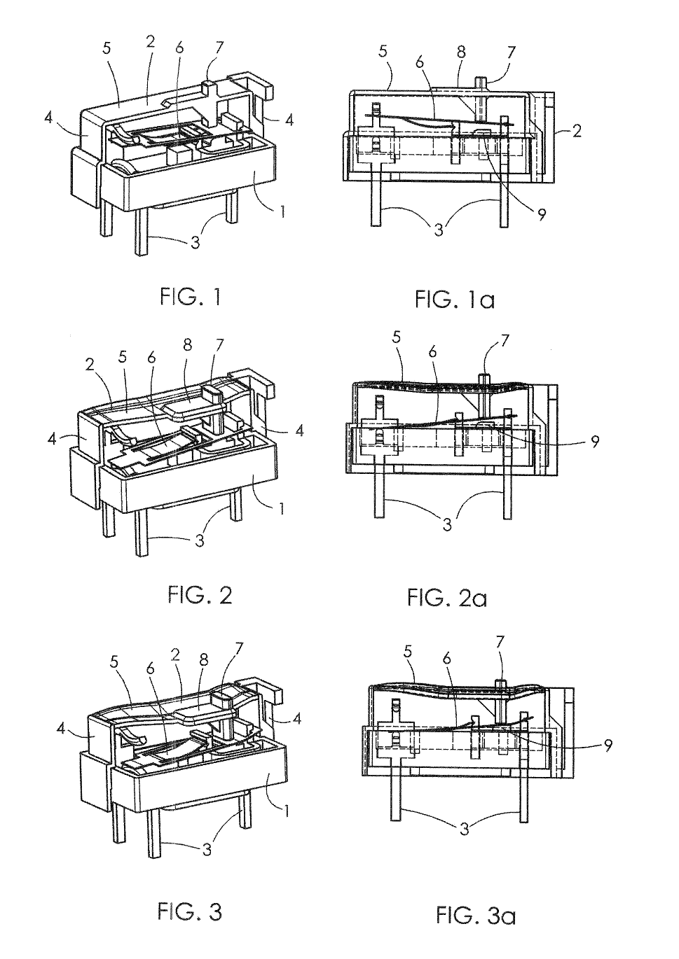

The micro-switch shown in FIGS. 1 to 3a comprises a switch base 1 and a switch cover 2. The switch base 1 has the constructional shape of an upwardly open trough, the floor of the switch base 1 is penetrated by contacts 3. The portions of the contacts extending from the base form terminals for the switch. The switch cover 2 has a substantially rectangular shape, with lateral wall sections 4 and a top wall section 5. The base 1 and the cover 2 form a housing for contacts 3 as well as for switch components 6.

The micro-switch shown in the Figures is, according to the invention, equipped with a one-piece switch cover 2. FIG. 1 shows that the switch cover 2 is formed in one piece with a plunger 7. The plunger 7 forms an actuating element for the switch component 6 inside the micro-switch. The plunger 7 has an outwardly protruding section as well as an inwardly protruding section, wherein the inwardly protruding section is supported by a reinforcement 8. The switch base 1 supports a stop 9 in the area below the plunger 7, and the plunger 7 can travel as far as this point as shown in FIG. 3a. FIG. 2a shows the switching point of the micro-switch, the plunger 7 here does not yet contact the stop 9. Up to this switching point the plunger 7 has been moved inwardly, for example, by 0.25 mm. As the switch component 6 is configured as a jump switch component, this is the point where the switching component 6 is changed over to another contact 3. FIG. 3a then shows the case where excessive forces act upon the plunger 7 causing it to travel to the stop 9.

FIGS. 2 to 3a show that with the plunger 7 moving an influence is exerted upon the switch cover 2. The plunger 7 is formed as a part of the top wall section 5, and this wall section 5, during transition from the shown rest position shown in FIG. 1a via the switching point shown in FIG. 2a to the final position shown in FIG. 3a, shows that it is distinctly dented.

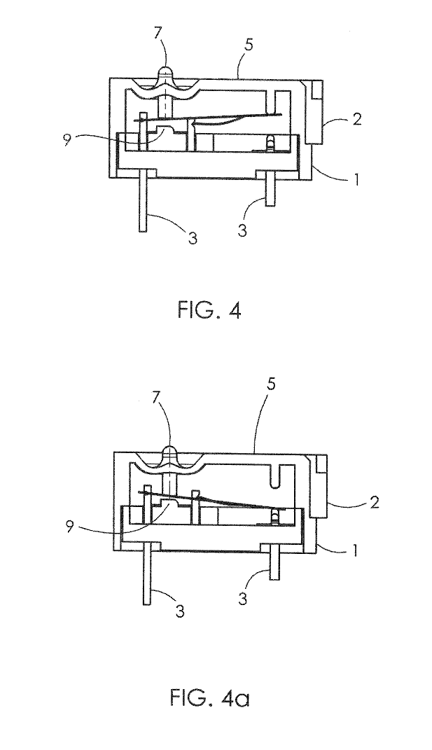

In the embodiment shown in FIGS. 4 and 4a the switch base 1 and the switch cover 2 are made of a soft material. As the plunger 7, forming a one piece or monolithic construction with the switch cover 2, moves by e.g. 0.4 mm in FIG. 4a, the top wall section 5 is partially dented.

In the embodiment of FIGS. 4 and 4a, the switch has only two contacts 3 forming a normally open micro switch. The normally closed contact is omitted to save material cost. A projection is formed on the cover 2 against which the switching component 6 bears in the rest position.

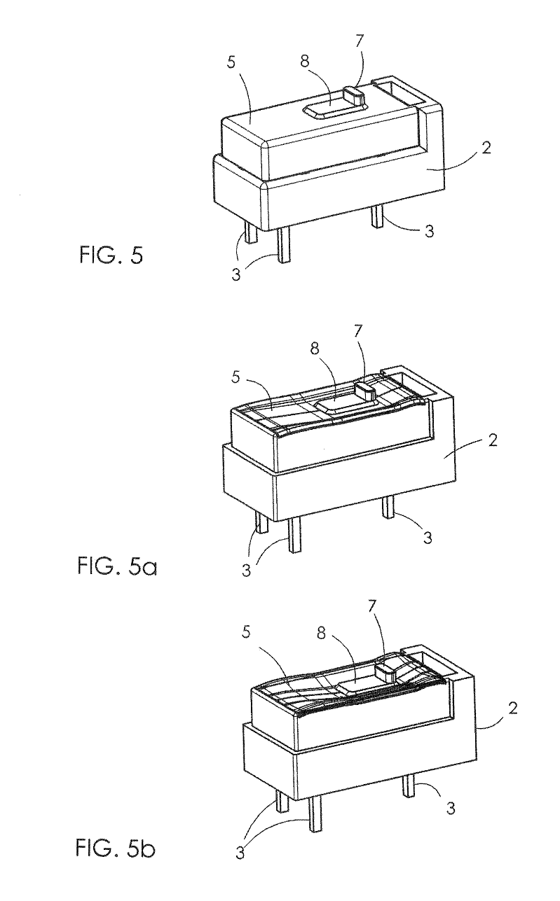

FIGS. 5 to 5b, by contrast, show again the switch from FIGS. 1 to 3a. The plunger 7 protrudes upwards from the top wall section 5. The reinforcement 8 is also arranged on the topside of the wall section 5. The state shown in FIG. 5 corresponds to the rest position of FIG. 1 and FIG. 1a. The top wall section 5 has a planar shape. In FIG. 5a the top wall section has already been dented. For this state shows the switching point as in FIGS. 2 and 2a. A more marked deformation of the top wall section 5 is shown in FIG. 5b, this state corresponds to the end position shown in FIGS. 3 and 3a.

A material bond exists between the switch base 1 and the switch cover 2 to seal the housing. The material bond may be formed by gluing or by welding.

The switch allows continued operation under water or covered by media. It can be sprayed with pressurized water such as a high-pressure cleaner without adversely affecting its function. In conjunction with a simple construction this is new for a “naked” switch (i.e. a switch without a surrounding protective construction). The switch is robust and tolerates strong forces of misuse. The simple construction means that its manufacture is very economic.

With the switch according to the invention the essential components, i.e. the plunger (actuating element), bellows (sealing sleeve) and cover, are combined to form a single component (multi-function cover). This cover is materially bonded to the base and thereby sealed. Preferably the material bond between cover and base is achieved by gluing. To this end the opposing respectively uninterrupted surfaces of the cover and base are pressed together. In this way a liquid adhesive is prevented from intruding into the switch during the gluing process. The same gluing process is used for sealing the pass-through points of the electric connections (terminals) against the base. In this way all potential intrusion paths of media into the switch are eliminated.

With regard to tightness a particularly positive effect is achieved by choosing the same material both for the cover and the base because this minimizes the load on the connection point in case of temperature and climate stresses occurring.

Alternatively, the material bonding may be achieved by welding. Laser welding is particularly suited for this process.

Generally speaking a distinction may be made with this design between “soft” and “hard” materials. The design of the multi-function cover has to be adapted for “soft” and “hard” materials.

With a cover of soft material (e.g. an elastomer such as PE-HD or ethylene-propylene-diene-rubber (EPDM)) there exists a plurality of effective shapes which make it possible for the actuating region to permit actuating travel. Even large actuating travels can be realized. All soft materials are difficult to be glued and some cannot be glued at all. In product design the sealing of electric connections is typically effected by casting with adhesive or plastic. In the case of soft plastics suitable for the cover this is difficult. Additional processes are required for activating the surfaces for the gluing process. Alternatively, the cover may be welded to the base, as mentioned above.

For a cover made of hard material (e.g. PA66GF30) flexibility is achieved, in particular, by minimizing the wall thickness. A thin-walled box comes to close to the optimum.

The area, which absorbs the force for the switch actuation, must be sufficiently reinforced in order to allow the switching forces to be introduced without lasting deformations. Ideally, for an injection-molded part, the injection point is located in this area.

Hard plastics are frequently easy to glue. The hard cover material is suited much better for further processing steps, in particular for the sealing of electric connections by casting with an adhesive or a plastic, in product design.

For covers made of a hard material a switching system with short actuating travel is required. The switch according to the invention shows a specially designed jump switching system which requires only a short actuating travel for switching.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. A micro-switch comprising: a housing formed by a switch base and a switch cover fixed to the switch base;
a switching mechanism disposed within the housing; and
an actuating element for operating the switching mechanism,
wherein the switch cover and the actuating element are configured as a one-piece, monolithic component.

2. The micro-switch of claim 1, wherein the actuating element is a plunger molded with the switch cover.

3. The micro-switch of claim 2, wherein the switch cover comprises wall sections and in that the plunger is molded into one of the wall sections.

4. The micro-switch of claim 3, wherein said one wall section has reinforcements in its wall thickness in the area of the plunger.

5. The micro-switch of claim 2, wherein the plunger comprises a first section protruding into the housing interior and a second section extending out of the switch cover.

6. The micro-switch of claim 1, wherein the switch cover is of a soft material.

7. The micro-switch of claim 6, wherein the soft material is ethylene-propylene-diene-rubber (EPDM).

8. The micro-switch of claim 1, wherein the switch cover is of a hard material.

9. The micro-switch of claim 1, wherein the switch cover and the switch base are formed from a similar material or from the same material.

10. The micro-switch of claim 1, wherein the switch base and the switch cover form a material bond with each other.

11. The micro-switch of claim 10, wherein the material bond is an adhesive bond.

12. The micro-switch of claim 11, wherein contacts protruding from the switch base (1) are glued to the switch base.

13. The micro-switch of claim 10, wherein the material bond is effected by welding.

14. The micro-switch of claim 2, wherein a stop for the plunger is provided in the switch base.

15. The micro-switch of claim 2, wherein the switch cover is an injection-molded product, the injection point of which lies in the area of the plunger.
